(19) United States
(12) Patent Application Publication
(10) Pub. No.: US 2008/0222074 A1
(43) Pub. Date: Sep. 11, 2008

(54) Method or corresponding system employing templates for creating an organizational structure of knowledge

(76) Inventors: Peter Lieberwirth, Carlisle, MA (US); Edmund Cuoco, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/070,902

(22) Filed: Feb. 21, 2008

Related U.S. Application Data
(60) Provisional application No. 60/902,768, filed on Feb. 22, 2007.

(51) Int. Cl. G06N 5/02

(52) U.S. Cl. 706/50

(57) ABSTRACT

As the amount of knowledge availability to a user grows, user become overwhelmed with information from sources, such as Web pages, electronic documents, media files, or links to online syndication services. The present invention solves this problem by creating an information collection with efficient knowledge access. In particular, a process selects a collection template and allows a user to determine at least one attribute for the collection template. Next, using a user's intended activity (e.g., a construction project) the process obtains data from all available knowledge sources to include in a collection and creates the collection using the collection template, at least one attribute, and the data. Thus, the process creates a collection with information directed to an intended activity from a vast amount of resources.

### RELATED APPLICATIONS

This application claims the benefit of U.S. Provisional Application No. 60/902,768, filed on Feb. 22, 2007. The entire teachings of the above application are incorporated herein by reference.

### BACKGROUND

Users obtain knowledge in a broad range of informational sources, such as Web pages, electronic documents, media files, and links to online syndication services. Users often try to organize knowledge repositories so they can be easily associated with an intentional activity, such as a research report, an educational activity or categorized list, experiment notebook, construction project, commercial venture, or leisure pursuit. Therefore, as a user tries to manage and access collections of information that are organized around specific purposes, the user becomes overwhelmed with information.

### SUMMARY OF THE INVENTION

The proposed invention provides an automated system made apparent through a series of templates for organizing, formatting, presenting, collaborating on, securing, archiving and/or managing collections of electronic information associated with an intended purpose.

Although enterprises, collaboration teams, and individuals can standardize on organizational structures for activities, these structures are usually domain specific, manually generated, and often “hard-wired” to specific workflow processes and naming conventions.

Knowledge repositories for new intentional activities, developed for different purposes, can use different organizational structures and security and access schemes, resulting in the possible desire for changes to an existing organizational structure. Because information sources comprise a knowledge repository residing in a wide range of data formats and located in various locations, such as a personal computer, networked computer, or computers accessible on the Internet, gathering knowledge sources is time-consuming. Further, some knowledge sources may be dependent on hypertext links, which change over time.

After gathering the knowledge sources, the knowledge source collection is difficult to archive, manage, and/or supplement because of the disparate nature of the individual sources. In certain cases, some of information sources are updated over a network and new knowledge sources are difficult to track and update. Therefore, introducing a knowledge repository enables users to be notified when updated relevant information is available on electronic networks so users can determine if the new information is applicable.

The present invention is a software tool for automating the creation and evolution of organizational structures for knowledge repositories purposely created for activities residing on a personal computer, on an Internet, and/or a networked server. These organizational structures may include not only an organizational schema or a choice of schemas, but presentation and formatting styles, collaboration and security rules, and publishing, storage, and/or archival options based on constraints identified by the user, such as the intention for using the collection information. An embodiment incorporates a method to automatically generate a comprehensive schema from outlines and documents that includes at least a portion of the above.

One embodiment involves using a template-based approach comprising basic customizable data model elements, which are applied to a specific domain, security, and/or usage schemes to match a user's requirements for information organization, indexing and tagging, presentation, collaboration, and/or storage.

By providing a level of automation, optimization, and/or predictability absent from existing techniques, a system employing embodiments of the present invention enables a user to set up a database accommodating organizational and informational desire and associates security and work processes as well as evolves and/or changes the collection organizational structure using the tool's templates. In addition, the system accumulates and/or manages metadata and/or related descriptive information for items associated with the collection and further provides views of the metadata corresponding to the intentions of the user.

In an embodiment, a system incorporates both static template processing and active template processing. The system, for example, provides the user a static template mechanism and process, which the user interacts with the templates by selecting pre-defined options. The template generates an organizational infrastructure prescribing how a knowledge repository can be used for its intended purpose. In an embodiment, the system provides active templates, which combines the static template mechanism with an automated interactive dialog with the user to help the user select advanced options, such as collaboration, security, access control, attestation, and/or archiving scenarios.

In an embodiment, a method or corresponding system creates a collection with efficient knowledge access. In particular, a system selects a collection template and determines at least one attribute for the collection template. In an embodiment, the attribute of the collection template includes at least one of the following: an archive, an archive format, or an archive security attribute. After determining the attribute, the system obtains data from multiple knowledge sources, where the data is based on an intended activity of a user. Next, the system then creates the collection using the collection template, with at least one attribute, and the data in such a manner as to allow efficient knowledge access of the multiple knowledge sources. After creating the collection, the system applies access security to the collection. In an embodiment, the system identifies at least one option for importing the data into the collection, where the options can be based on meta-data associated with one or more source documents, meta-data conforming to one or more types identified in the collection, a map of meta-data from a format defined in the collection.

In an embodiment, the system associates a name for the collection. In other embodiments, the system identifies at least one annotation for an item in the collection and creates the collection using the at least one annotation. In another embodiment, the system identifies at least one keyword for use in identifying data for the collection based on a predefined keyword associated with the template. In yet another embodiment, the system associates a type of display for the collection using at least one of the following types: a blog, wiki, or webpage. In still yet another embodiment, the system identifies options for formatting data in the collection by performing at least one of the following: displaying the data ordered by a time stamp associated with the data; displaying the data ordered by a subject; displaying the data associated with the meta-data in the collection. In one embodiment, the meta-data includes at least one of the following: a keyword, tag, author, license right, or custom metadata.

In an embodiment, the system identifies at least one option for recording authorship of entries and related information within the collection. In an embodiment, the authorship includes at least one of the following: anonymous authorship, authorship as defined by a user identification (ID), or authorship via secure attestation. In yet another embodiment, the system identifies options for a third-party attestation for authored content in order to secure provenance of information. In still yet another embodiment, the system identifies at least one option for time-stamping of collection data using a local system clock or time-stamping with a trusted third-party source of time.

In another embodiment, the system identifies choices for publishing data maintained by the collection in an industry formats. In yet another embodiment, the system identifies one or more custom keywords used within the collection to indexing and tag data; enables the collection to record licensing metadata associated with items imported into the collection; and enables the collection to record the provenance of items imported into the collection.

In this way, embodiments of the present invention use a corresponding method or system to create a collection or organizational structure using templates. The templates can be used for organizing, formatting, presenting, collaborating on, securing, archiving and/or managing collections of electronic information associated with an intended purpose, intentional activity or specified activity.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 depicts a screen view for creating information collection in an epidemiological study according to an embodiment of the present invention.

FIG. 2 depicts a screen view for creating an information collection for a recipe collection according to an embodiment of the present invention.

FIG. 3 depicts a screen view for configuring collaboration properties for an information collection associated with a recipe collection according to an embodiment of the present invention.

FIG. 4 depicts a screen view for modifying an organizational structure of a collection, tagging configuration information, and tracking properties according to an embodiment of the present invention.

FIG. 5 depicts a screen view for formatting a user collection and providing annotations in other formats according to an embodiment of the present invention.

FIG. 6 depicts a screen view for user archiving and service options according to an embodiment of the present invention.

FIG. 7 is a block diagram representing database scheme for a collection according to an embodiment of the present invention.

FIG. 8 is a block diagram depicting a network for using a collection via multiple communications paths according to an embodiment of the present invention.

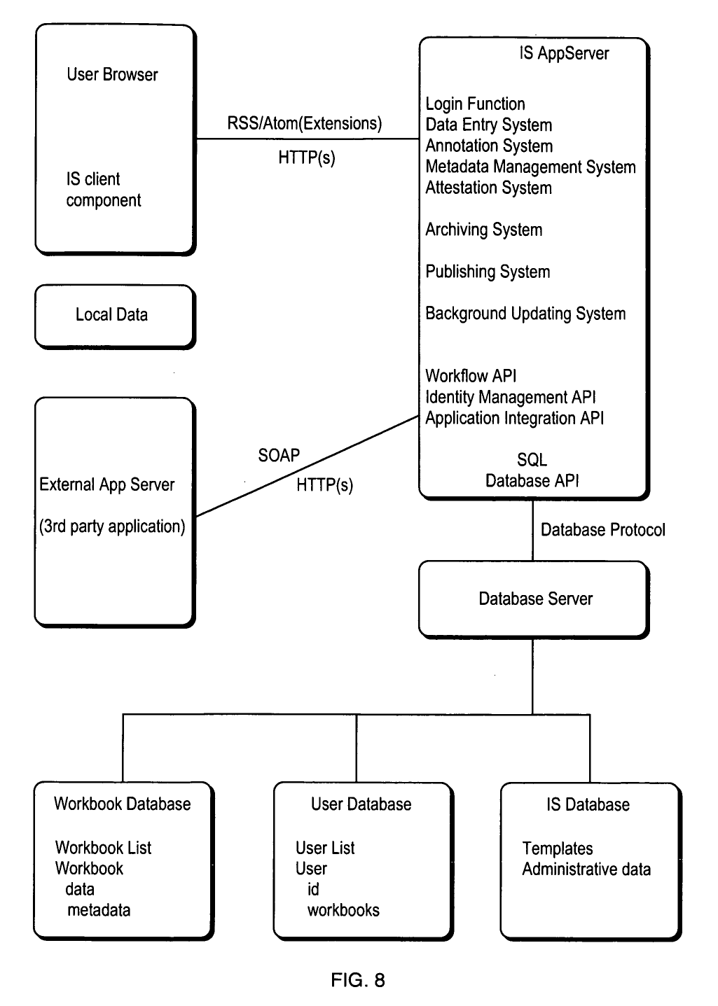

FIG. 9 is a block diagram depicting network nodes to create a collection according to an embodiment of the present invention.

FIG. 10 illustrates a flow diagram of an example process for creating a collection according to an embodiment of the present invention.

### DETAILED DESCRIPTION OF THE INVENTION

A description of preferred embodiments of the invention follows.

A process according to an example embodiment of the present invention comprises identifying generic headings for collections and/or sub-collections based on a customary organizational structure for similar intentional activities, enabling a range of security, workflow and meta-data management options, and identifying storage and archiving choices.

For example the process may perform the following in any order including the omission of part of the process:
1. Specifying organizational properties of the collection, such as at least a name of the collection;
2. Identifying collaborative features, such as invitations to the collaborative process as well as roles and notification schemes;
3. Identifying whether annotations, keywords and/or tags for collections and information contained in collections are to be used, how to present the same and how tracking, if any, is accomplished;
4. Determining attributes of archiving the collection, including but not limited to included and/or excluded content from an archive, archive format, and/or archive security attributes;
5. Identifying options for importing meta-data associated with source documents imported in the system, including but not limited to importing defined meta-data for a source document or importing meta-data conforming to types identified in the template, mapping meta-data from one format or system to another defined in the template, or not importing meta-data;
6. Identifying keywords used within the collection, for, but not limited to, indexing and/or tagging data if appropriate;
7. Enabling the system to record licensing metadata associated with items imported into the system if appropriate;
8. Enabling the system to record the provenance of items imported into the system if appropriate;
9. Identifying options for recording authorship of entries and related information within the system, including but not limited to anonymous authorship, authorship as defined by system user Identification (ID), and/or authorship via secure methods of attestation;
10. Identifying options for third-party attestation for authored content to secure provenance of information;
11. Identifying options for time-stamping of information imported into the system or authored within the system, including but not limited to not time-stamping, time-stamping with a local system clock, or time-stamping with a trusted third-party source of time;
12. Identifying choices for publishing data maintained by the system, for example but not limited to publishing the data in common industry format or the like, such as Adobe PDF, or Microsoft Word, or Open Office formats;
13. Identifying choices for displaying data maintained by the system, for example but not limited to common World Wide Web formats, such as a blog, wiki, or general-purpose webpages;
14. Identifying choices for displaying and publishing data maintained by the system in formats associated with domain specific citation standards; and
15. Identifying options for formatting data published or displayed by the system, including, but not limited to displaying the data ordered by time stamps associated with the data, displaying the data ordered by data subject, by any meta-data associated with the data in the system, keywords, tags, author, license rights, custom metadata, or the like.

In an embodiment, the process may also perform one or more of the following for specifying security attributes, and can include, but are not limited to:
16. Identifying users with access to the information and how to access the information.
17. Identifying the level of security applicable to the collection or sub-collection.
18. Identifying options for a user registration with parameters relating to the collection.
19. Identifying if an external data source, such as an LDAP or Active Directory implementation is usable for obtaining user identification information and/or resolution.
20. Identifying types of access control usable within the collection.
21. Identifying whether data in the system will be made confidential, via means such as encryption, to further limit access to information within the system.

In an embodiment, the process allows option choices and configuration of the following characteristics:
22. Identifying parameters for configuring the system for use with an external authentication database, such as an LDAP or Active Directory system;
23. Identifying parameters for configuring the system for use with an external application; or
24. Identifying parameters for configuring a mechanism for updating data in the system with information from the Internet

In an embodiment, the process allows for preparing and/or modifying templates within software application (e.g., a template-editing system) using the following:
25. Embedding template together;
26. Formatting (presentation) rules and content (information) rules;
27. Be multi-staged (one template can be applied to another, and so on);
28. Deriving automatically from input material, which may be standardized (e.g., text outlines, XML, or the like);
29. Deriving a template existing content (an outline derived from a table of contents, for example);
30. Creating a template editor software tool; and
31. Modifying with a template editor software tool.

In an embodiment, a process or software application implementing collection templates uses existing standards, such as XML and XSLT/XSL. In use, the software application applies, XSLT to XML input to produce a different XML output, which is consistent with IS templating rules as defined in the XSLT standards documents as proposed by the World Wide Web Consortium (e.g., “XSL Transformations”, W3C Recommendation Version 1.0 dated 16 Nov. 1999, and Version 2.0 dated Jan. 23, 2007). For example, the software application performs the following:
32. Defines default templates in an XML structure;
33. Formats templates defined using an XML document conformant to XSLT and/or XSL; and
34. Defines content templates using an XML document conformant to XSLT and/or XSL.

After the templates are implemented, a process for utilizing parameters characterizing a user's intended purpose for the collection is executed. In an embodiment, an Intention System (IS) or collection creator system provides a mechanism for implementing the processing of templates where the template options displayed by a user interface are translated to internal system data structures for use by the system during operation, or conversely, templates are applied to data contained within the system to display collection data. An example process includes the following:
35. Automatically generate a defined XML structure conforming to the requirements of an IS template given an appropriate standardized input, such as an outline in any number of formatting languages;
36. Generate a defined XML structure conforming to the requirements of an IS template given an existing document or data store whereby the existing document or data store is read in, and abstracted to generate an outline; and
37. Allowing an end-user (via a tool and/or process) to directly or indirectly create a template by editing and/or choosing by hand using a software application the content of the template, where the tool and process use the user input to create a defined XML structure conforming to the requirements of an IS template.

Additional steps 38, 39, and 40, analogous to steps 35, 36, and 37, can be applied, where the result is a formatting template that could be applied to the output of steps 35, 36, or 37 to derive a specific look or presentation format. An example technical approach would be for step 41, 42, or 43 to create an XSLT document that contains graphical formatting rules.

Further steps 44, 45, and 46, analogous to steps 35, 36, and 37 can have the result as a content template that can then be applied to the output of steps 35, 36, or 37, to derive a additional content rules about content within the template when in use. An example technical approach would be for steps 44, 45, or 46 to create an XSLT document that contains rules that constrain and/or enable different types of content within a specific template.

In an embodiment, one or more of steps 35, 36, 37, 38, 39, 40, 41, 42, or 43 can be applied once or in combination to derive a specific final template within the context of an IS application. In an embodiment, the result of a formatting template can be applied to the output to derive a specific look or presentation format, such as by creating a DXSLT document that contains graphical formatting rules; to derive a additional content rules about content within the template when in use, such as by creating an XSLT, document that contains rules that constrain and/or enable different types of content within a specific template; or some combination to derive a specific template within the context of an application.

In an embodiment, a user logs into an Application Server, such as the Intention System (IS), using a browser, and optionally an IS client component, to access the maintenance system to create a new collection. The maintenance system presents the user with the choice to edit an existing collection or create a new one. In the example where the user creates a new collection, the IS Application Server displays to the user a sequence of user interface dialogs that control the creation of a collection-specific template through the following steps. The IS system retrieves a generic template from the database, and displays to the user's browser a sequence of user interface screens that guide a dialog to select specific template attributes for this collection, thus transforming the generic template into a template customized.

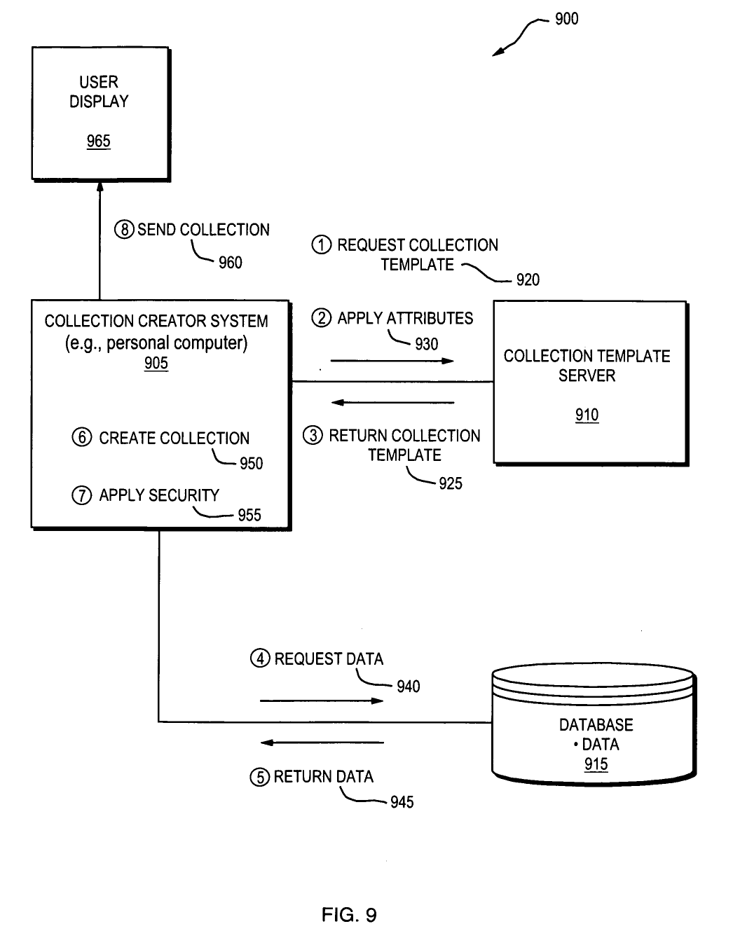

For example, steps 1 through 15 presented above can be taken via this dialog, and collection attributes including its name, the use of annotations, keywords, meta-data and license rights usage, or the like can be associated with the template thereby enforcing upon users of the collection the requirements now associated with this specific collection. It should be understood that the Intention System, Application Server, collection maintenance system, and other components of this process may be fully or partially incorporated in a single network node, such as the collection creator system of FIG. 9, or multiple nodes. The configuration presented above is merely for illustrative purposes.

Moreover, the collection maintenance system guides the user in selecting security attributes of the collection, using the templating capability. These attributes may include the security attributes listed in steps 16 through 21 above or the like. The collection maintenance system guides the collection owner in determining the security attributes that will be enforced in the collection. In a typical implementation, security attributes can apply to different scopes of the collection, for example, some security attributes applies to the overall collection, such as the level of authentication and authorization that is used to access the collection, and some security attributes will apply to entries within a collection. Example security attributes that apply to an entry in a collection include whether entries support secure time stamping or attestation, and whether individual entries use additional authentication or authorization to access. When the collection is instantiated as an object in a server, the workbook database for the collection will contain attributes, such as security attributes, that apply to the overall collection and individual entries within a collection, and the user database will contain security attributes that apply to users.

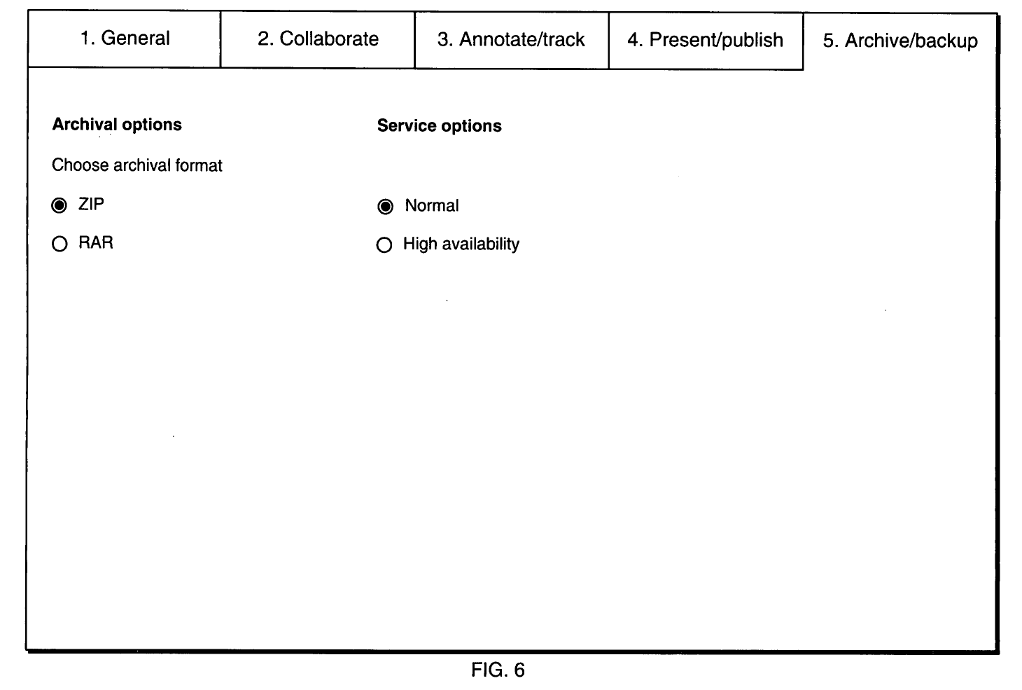

Other attributes of the operation of the Intention System are provided to the collection creator via the collection maintenance system. An example is shown in FIG. 6, and includes setting parameters for various components of the Intention System. Templates are used to set the attributes, in particular, the allowable functions for archiving information, for publishing information, for meta-data management, including allowable meta-data, the ability to create and edit new meta-data, whether existing meta-data within entries imported into the system is preserved, and how meta-data is to be displayed. The background updating system is configured using templates managed by the collection maintenance system to allow, disallow, or restrict the capability of the system to automatically retrieve information from external sources. The collection maintenance system also includes templates that configure the ability of the system to connect to and integrate with external applications, such as work flow systems, identity management systems, and proprietary third-party applications. Technical attributes of such connection and integration can be configured; typical examples may include protocols, as shown in FIG. 6, as well as application location, authorization and authentication information, and application-specific parameters.

Display attributes of the project being created are managed by the collection maintenance system utilizing templates. Display attributes include, but are not limited to, features such as whether the collection is ordinarily displayed by topic, by date, and what level of information is presented to the user upon initial view of any entry. The ability of the end-user to select alternate views and visualization of the information is also configured using template.

The template-editing system is also managed through the collection maintenance system. The template editing system provides the collection creator the capability to perform some modification of existing templates to customize the collection being created. Using the template editing system, the user can combine existing templates to offer custom capabilities, or to create new templates based on existing templates to provide further configuration of a new collection.

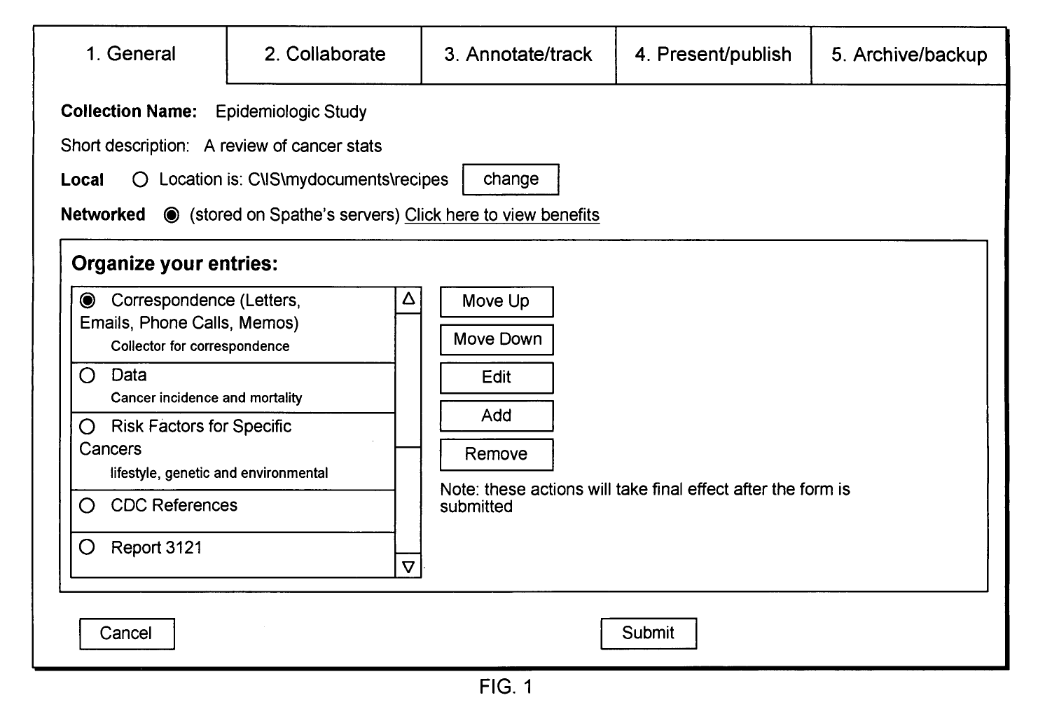

FIG. 1 shows how a user sets up an information collection for an epidemiological study, and it introduces, through a series of four user interface screens depicting visual representations of templates, how a user specifies further aspects of the collection. FIG. 1, for example, allows the user to specify the collection name and allows for a brief optional description. The user can also specify whether the collection resides on the user's computer or on a networked computer. The user also identifies collection headings that can be used as organizational containers for similarly associated information. The user submits the general specifications and can choose to select another tab. It should be understood that these user interface screens are merely examples, and alternative user interface representations are possible.

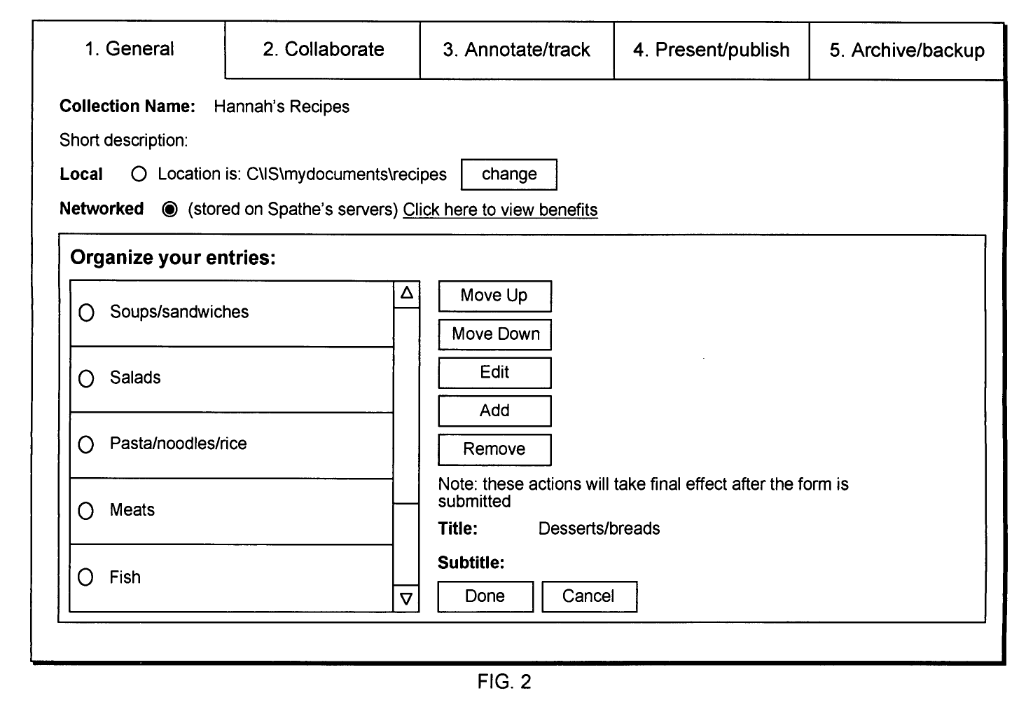

FIG. 2 demonstrates how a user sets up a collection to support recipes. Similar types of configurations are available as is provided in FIG. 2.

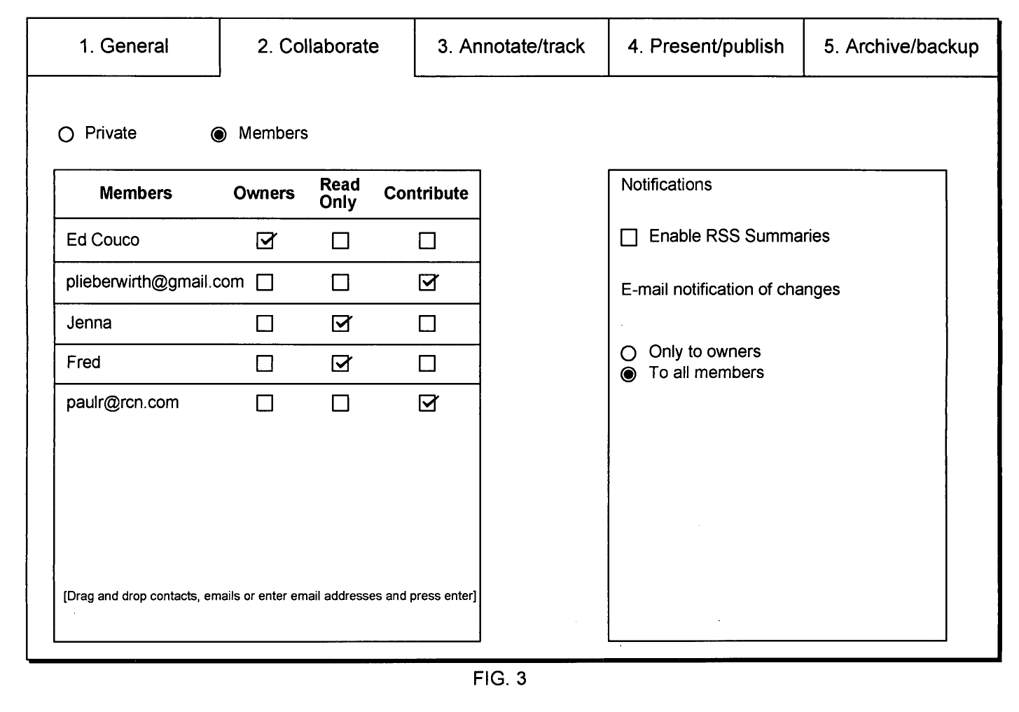

FIG. 3 shows how a user specifies who is also an owner to the collection, who has read-only access, and who can contribute to a collection, by using an e-mail and/or contact information. The user can also identify how collaborators are notified in the event of changes to the collection.

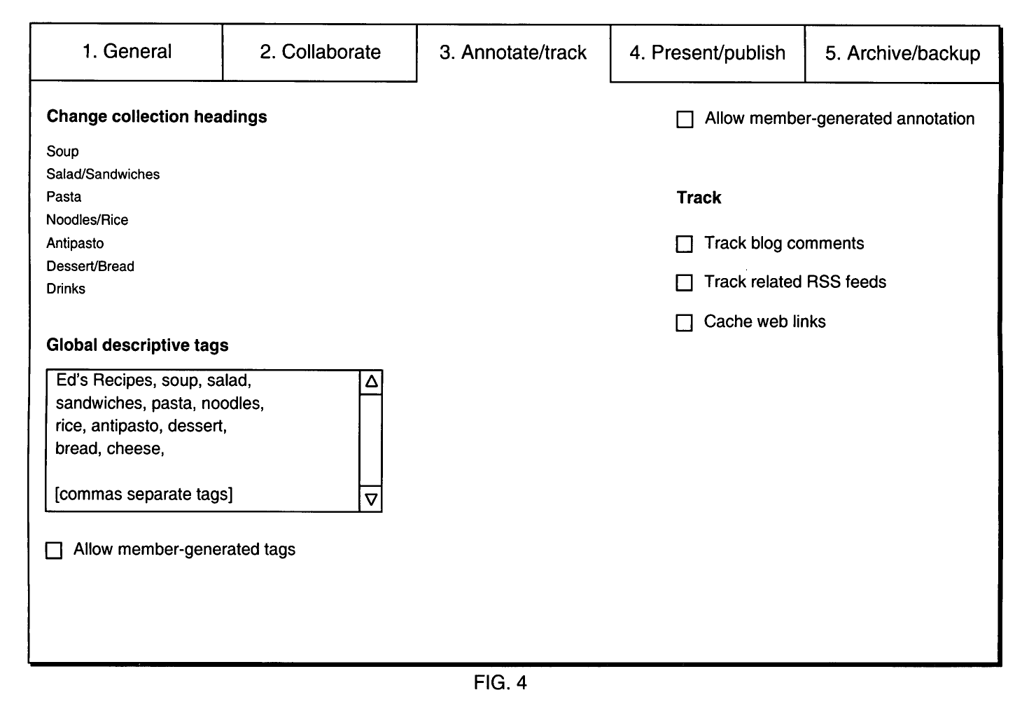

FIG. 4 identifies how a user employs tags and tacks information from other web services that are associated with information/data in the collection. Moreover, a user can permit user annotations. A user also has the option to enable user-generated and industry-agreed-upon tagging schemes.

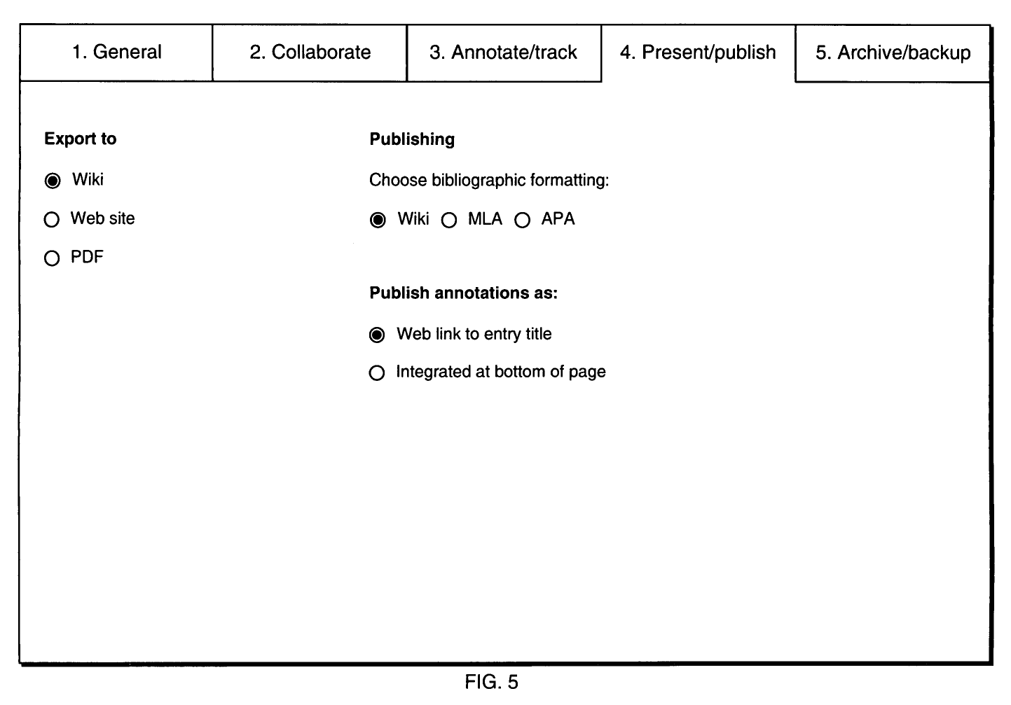

FIG. 5 show various publishing, export, and formatting options that a user can choose for the collection.

FIG. 6 demonstrates various archival and back-up options available to the user for the collection. In an embodiment, an example process provides instantiating templates to describe attributes for a collection management system. The process performs instantiating via a sequence of user interface screens, which are extended to address additional attributes of a collection management system that can be different from those depicted in the example figures.

### Intention System Template Example

An embodiment encodes collection templates using XML. In an implementation, the data entry fields in the user interface are derived from a generic collection template and the process of filling in the fields yields a collection definition template that is specific to this Intention System collection. A simplified example of such a generic template, in pseudo-XML code is provided. The example template is merely for illustrative purposes and does not reflect the full extent in which a collection template may contain.

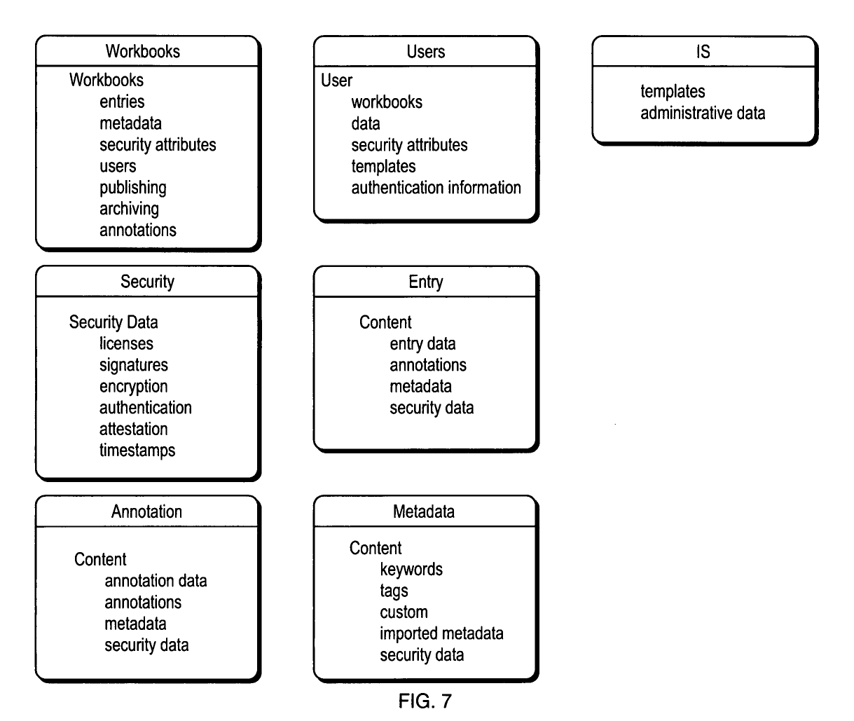

Once the collection-specific template is used to define the characteristics and attributes of a collection, the collection-specific template is stored in the Intention System database as the template for that collection—or, depending on the template parameters, on the user's hard drive or database. Additionally, information in the template is used to populate the various data tables and entries in the databases containing the collection. In FIG. 6, for example, the database descriptions include an abstract schema that exemplifies the data as it is structured in the databases. FIG. 7 incorporates more detail about the database schema. Information derived from the processing of the template is used to fill in the actual database fields within the database, as defined by the relevant schemas. FIG. 7 shows an example database schema, at an abstract level for purposes of clarity. One skilled in the art will recognize the meaning and intent of this abstract schema. FIG. 7 describes a database with several tables.

The template processing includes a Workbook, Users, Security, Metadata, Entry, and Annotation tables. As the collection-specific template is processed, data gathered is used to configure fields in the appropriate database table. Information from template processing relevant to how a workbook can be published, archived, and what kind of security attributes, as examples, will be instantiated in a Workbook table. Rules about metadata and how it will be processed will also be stored in the Workbook table. Once the collection is in use, users will fill in entries, make annotations, and so on, and these will be reflected in the appropriate tables, for example the entry table, the Annotation table, and the Metadata table. The security table contains data and rules configured during template processing time to set the required security attributes. Once the collection is instantiated in the database, it is available for users to access the collection. The collection-specific template created when the collection was created is used by the Intention System to decide how to display the collection to an end-user, and what end-users see as the collection's capabilities.

FIG. 9 is a block diagram 900 depicting network nodes to create a collection according to an embodiment of the present invention. In particular, a collection creator system 905, such as a personal computer or server, requests a collection template 920 from a collection template server 910. For example, the collection creator system 905 allows the user to interact with the collection template server 910 to select options based on an intentional activity. The collection template server 910 generates an organizational infrastructure prescribing how a knowledge repository can be used for its intended purpose for inclusion in the template. The collection template server 910 provides active templates, which combines the static template mechanism with an automated interactive dialog with the user to help the user select advanced options, such as collaboration, security, access control, attestation, and/or archiving scenarios. A user applies these attributes 930 to the collection template via the collection creator system 905.

Once the collection creator system 905 receives the collection template and associated attributes, the collection creator system 905 requests data 940, relating to an intended activity or purpose from a database 915, which returns the data 945. It should be understood that the data for the intended activity or purpose may also be provided by the collection template server 910, the collection creator system 905, or other suitable location. After receiving the data, the collection creator system 905 creates a collection 950 based on the collection template, attributes, and data. Next, the collection creator system 905 applies security 950 to the collection to allow the collection to be publicly stored freely transmitted. If applicable, the collection creator system 905 sends the collection 960 to a user display 965 for review. It should be understood that in an embodiment, the collection template server 910 stores collection template in memory, such as a hard disk, flash memory, or the like. In other embodiments, the collection template 910 may retrieve the collection template(s) for return from a database or other suitable storage medium.

It should be further understood that example embodiment of FIG. 9 is being presented for illustrative purposes and each of these processes can be performed in any number of orders or sequences.

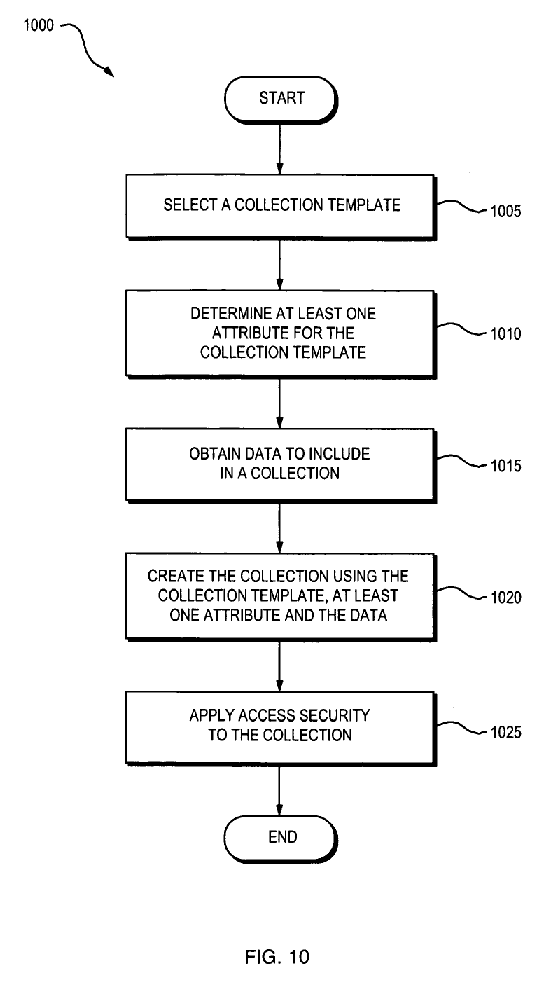

FIG. 10 illustrates a flow diagram of an example process for creating a collection according to an embodiment of the present invention. After beginning, a process 1000 selects a collection temple at step 1005. Next, the process 1000 determines at least one attribute for the collection template at step 1010. An example of an attribute may include an archive, an archive format, or an archive security attribute. At step 1015, the process 1000 obtains data to include in a collection or organizational structure. The process 1000 typically obtains data from multiple knowledge sources (e.g., Web pages, electronic documents, media files, links to online syndication services, or the like) based on an intended activity of a user. For example, an intentional activity of the user can include a research report, an educational activity or categorized list, experiment notebook, construction project, commercial venture, or leisure pursuit. Therefore, a user becomes overwhelmed with information. Thus, allowing the obtained data to be directly related to the user intention.

After obtaining the data, at step 1020, the process 1000 creates the collection using the collection template, at least one attribute, and the data in such a manner as to allow efficient knowledge access. That is, the process 1000 creates a collection based on user preferences or intended activity with the appropriate attributes and template in such a manner as to allow efficient knowledge access of the multiple knowledge sources. After creating the collection, the process 1000 applies access security to the collection. In an embodiment, the security can include an encryption key, churn key, or the like. It should be understood that a user or selection process can be used to select the collection template, attributes of the collection template, the intention activity or a combination thereof. An example of such a process is presented above as the Intention System template example.

In an embodiment, individual users may have a custom version of the collection template, derived from the overall collection-specific template that may restrict that individual user's capabilities with respect to that collection. Also in an advanced version of the Intention System, templates can be modified by the collection owner after the collection was initially created.

The following example collection template is encoded in an XML-like format employing an example embodiment of the present invention:

```
<IS Example Template>
  <template version> 0.1 </template version>
  <collection>
    <name> sample collection name </name>
    <annotation attributes>
      <annotations allowed> yes </annotations allowed>
      <anonymous annotations allowed> yes </anonymous annotations allowed>
      <annotation presentation details> above, below, rightside, leftside,
color:r:gb:xyz </annotation presentation details>
    </annotation attributes>
    <archiving attributes>
          <contents> all, summary </contents>
        <format> zip </format>
        <security attributes> none, encrypted, signed </security attributes>
      </archiving attributes>
    <keyword attributes>
      <template mandated keywords> keyword a </template mandated keywords>
      <keywords not permitted>
        misleading keyword
        obsolete keyword
      </keywords not permitted>
      <custom keywords> allowed, denied </custom keywords>
    </keyword attributes>
    <metadata attributes>
      <import> yes, no, custom </import>
    </metadata attributes>
    <licensing attributes>
      <import> yes, no, custom </import>
      <require> ys, no </require>
    </licensing attributes>
    <provenance attributes>
      <origin> origin information </origin>
      <author> author information </author>
    </provenance attributes>
    <entry attributes>
      <authorship> anonymous, authentication required, secure attestation required
</authorship>
      <co-signatures> allowed, required, notAllowed </cosignatures>
      <time-stamping> none, localClock, trustedThirdParty </time-stamping>
    </entry attributes>
    <publishing attributes>
      <formats allowed> PDF, RTF, XML </formats allowed>
    </publishing attributes>
    <display attributes>
      <wiki> yes, no </wiki>
      <wiki format> wiki format description </wiki format>
      <blog> yes, no </blog>
      <blog format> blog format description </blog format>
      <web page> yes, no </web page>
      <web page format> web page format description <web page format>
      <IS> byTime, bySubject, byKeyword, byAuthor, byMetadata, custom </IS>
    </display attributes>
    <security attributes>
      <level> none, private, shared </level>
      <external identity management system>
        <present> yes, no <</present>
        <location> network address </location>
      </external identity management system>
      <access control> none, username/password, directory, openID, smart card,
custom <access control>
      <confidentiality>
        <required> yes, no </required>
      <encryption type> AES, tripleDES </encryption type>
      </confidentiality>
    </security attributes>
  </collection>
</IS Example Template>
```

It should be understood that any of the processes disclosed herein, such as creating a collection or the flow diagram of FIG. 10, may be implemented in the form of hardware, firmware, or software. If implemented in software, the software may be processor instructions in any suitable software language and stored on any form of computer readable medium. The processor instructions are loaded and executed by a processor, such as a general purpose or application specific processor that, in turn, performs the example embodiments disclosed herein.

While this invention has been particularly shown and described with references to example embodiments thereof, it will be understood by those skilled in the art that various changes in form and details may be made therein without departing from the scope of the invention encompassed by the appended claims.

GLOSSARY

| | |
|---|---|
| Annotation System | Mechanism implementing ability to add commentary to data within the system |
| Application Integration API | System programming component that facilitates integration with external |
| | applications; useful in bulk import of data or data visualization scenarios |
| Application Server | A software engine that delivers applications to client computers |
| Attestation System | Mechanism implementing ability for authors to electronically attest to data |
| | within the system, including electronic signatures, and co-signatures. |
| Archiving System | Mechanism implementing ability for system to store data for backups, |
| | transports, or export to other systems. |
| Background Updating System | Mechanism that, for selected data, notifies the system if the source of that data |
| | is updated, allowing users of the system to import the updated data into the |
| | system, either automatically or through user choice. |
| Collection Maintenance System | Mechanism implementing ability to structure and issue system data in various |
| | formats commonly used for off-line viewing, such as printing. |
| Display System | Mechanism implementing ability to display system data in various on-line |
| | formats available to users in real-time. |
| Identity Management API | System programming component that facilitates integration with authorization |
| | and authentication systems such as LDAP directories |
| Knowledge Repository | A collection of information organized and managed in support of a specific |
| | purpose or activity |
| Login Function | Sub-system for authenticating a user to the system |
| Meta-data Management System | Mechanism implementing meta-data support within the system, including as |
| | examples, types of meta-data allowed, not permitted, required, meta-data |
| | definitions, and the ability to parse and store meta-data. |
| Publishing System | Mechanism implementing ability for system to manage infrastructure |
| | necessary to support multiple projects within a system. |
| Work flow API | System programming component that facilitates integration with enterprise |
| | Work flow systems. |

What is claimed is:

1. A method for creating a collection with efficient knowledge access, comprising:
selecting a collection template;
determining at least one attribute for the collection template;
obtaining data from multiple knowledge sources, where the data is based on an intended activity of a user;
creating the collection using the collection template, the at least one attribute, and the data in such a manner as to allow efficient knowledge access of the multiple knowledge sources; and
applying access security to the collection.

2. The method of claim 1 further comprising identifying at least one option for importing the data into the collection.

3. The method of claim 2 wherein identifying options for importing the data is based on meta-data associated with one or more source documents, meta-data conforming to one or more types identified in the collection, a map of meta-data from a format defined in the collection.

4. The method of claim 1 wherein the attribute of the collection template includes at least one of the following: an archive, an archive format, or an archive security attribute.

5. The method of claim 1 further comprising providing a name for the collection.

6. The method of claim 1 further comprising:
identifying at least one annotation for the collection; and
creating the collection using the at least one annotation.

7. The method of claim 1 further comprising: identifying at least one keyword for use in identifying data for the collection based on a predefined keyword associated with the collection template.

8. The method of claim 1 further comprising associating a type of display for the collection using at least one of the following types: a blog, wiki, or webpage.

9. The method of claim 1 further comprising identifying options for formatting data in the collection by performing at least one of the following: displaying the data ordered by a time stamp associated with the data; displaying the data ordered by a subject; displaying the data associated with the meta-data in the collection.

10. The method of claim 9 wherein the meta-data includes at least one of the following: a keyword, tag, author, license right, or custom metadata.

11. The method of claim 1 further comprising identifying at least one option for recording authorship of entries and related information within the collection.

12. The method of claim 11 wherein the authorship includes at least one of the following: anonymous authorship, authorship as defined by a user identification (ID), or authorship via secure attestation.

13. The method of claim 1 further comprising identifying options for a third-party attestation for authored content to secure provenance of information.

14. The method of claim 1 further comprising identifying at least one option for time-stamping of collection data using a local system clock or time-stamping with a trusted third-party source of time.

15. The method of claim 1 further comprising identifying choices for publishing data maintained by the collection in an industry formats.

16. A method as in claim 1 further comprising:
identifying one or more custom keywords used within the collection to indexing and tag data;
enabling the collection to record licensing metadata associated with items imported into the collection; and
enabling the collection to record the provenance of items imported into the collection.

17. The method of claim 1 further, comprising:
identifying access rights to the data;
identifying user registration parameters to apply to the collection; and
identifying if an external data source is usable for user identification information.

18. The method of claim 1 further comprising: implementing the collection by using templates with existing standards including at least one of the following: XML, XSLT/XSL, XSLT, XML input producing a differing XML output, or XSLT rules.

19. The method of claim 1 further comprising automatically generating a defined XML structure as a representation of the collection template.

20. The method of claim 1 further comprising allowing a user to create a collection by editing a software application having the content of the collection template.

21. The method of claim 1 wherein the user provides input to create a defined XML structure conforming to the requirements of the collection template.
